(19) United States
(12) Patent Application Publication
(10) Pub. No.: US 2012/0019150 A1
(43) Pub. Date: Jan. 26, 2012

(54) POWER SUPPLY DEVICE AND LIGHTING SYSTEM HAVING THE SAME

(75) Inventors: Chang Soo YANG, Gyeonggi-do (KR); Paul JUNG, Gyeonggi-do (KR)

(73) Assignee: SAMSUNG ELECTRO-MECHANICS CO., LTD., Gyunggi-Do (KR)

(21) Appl. No.: 13/052,645

(22) Filed: Mar. 21, 2011

(30) Foreign Application Priority Data
Jul. 26, 2010 (KR) 10-2010-0071935

(51) Int. Cl. H05B 37/02; H02J 1/10

(52) U.S. Cl. 315/153; 307/151; 315/161

(57) ABSTRACT

Disclosed herein are a power supply device and a lighting system having the same. The lighting system includes a power supply device including at least two converters that receive AC power and convert it into DC power and selectively outputting any one DC power thereof; and a plurality of LED lighting units each receiving the DC power from the power supply device and operating. The lighting system can stably supply power and facilitate maintenance thereof due to the use of the integrated power supply device.

### CROSS REFERENCE TO RELATED APPLICATION

This application claims the benefit of Korean Patent Application No. 10-2010-0071935, filed on Jul. 26, 2010, entitled “Power Supply And Lighting System Having The Same”, which is hereby incorporated by reference in its entirety into this application.

### BACKGROUND OF THE INVENTION

1. Technical Field

The present invention relates to a power supply device and a lighting system having the same, and more particularly, to a power supply device capable of stably supplying power and a lighting system having the same.

2. Description of the Related Art

A fluorescent lamp, a halogen incandescent lamp, a light emitting diode (LED), and the like are generally used in a lighting apparatus. Among others, the LED has advantages of a long life span, small power consumption, a variable color temperature, and a high brightness, such that the use thereof has recently increased. For example, the LED has been used as indoor lighting, outdoor lighting, scenery lighting, stand lighting, a backlight of a display, and the like.

Meanwhile, the life span of the LED that is used as a light source in a lighting device using the LED is excellent. However, the life span of the power supply device for supplying DC power to the LED is not equivalent to that of the LED. Therefore, a problem arises in that the power supply device cannot stably supply power to the LED when being used for a long period of time. In addition, every light module configured of a plurality of LEDs is generally provided with the power supply device, which supplies power to the light modules. In this case, it is difficult for all of the light modules to emit the same brightness by receiving uniform power from the power supply device.

### SUMMARY OF THE INVENTION

An object of the present invention is to provide a unit capable of stably performing power supply.

According to an exemplary embodiment of the present invention, there is provided a power supply device, including: a plurality of converters each receiving AC power and converting it into DC power, and generating error signals at the time of an abnormal operation; an error detector determining which converters are normally operating from the error signals and outputting a selection signal for selecting one of the normally operating converters according to operation ranks; and a power selector receiving DC power from the converters and selecting and outputting one DC power according to the selection signal.

According to another exemplary embodiment of the present invention, there is provided a power supply device, including: a plurality of converters each receiving AC power and converting it into DC power; a power sensor determining which converters are normally operating by sensing DC power of the converters and outputting a selection signal for selecting one of the normally operating converters; and a power selector receiving DC power from the converters and selecting and outputting one DC power according to the selection signal.

According to another exemplary embodiment of the present invention, there is provided a lighting system, including: a power supply device including at least two converters that receive AC power and convert it into DC power and selectively outputting any one DC power thereof; and a plurality of LED lighting units each receiving the DC power from the power supply device and operating.

### BRIEF DESCRIPTION OF THE DRAWINGS

FIG. 1 is a block diagram showing a configuration of a lighting system according to an exemplary embodiment of the present invention;

FIG. 2 is an example showing an internal configuration of the power supply device of FIG. 1;

FIG. 3 is another example showing the internal configuration of the power supply device of FIG. 1; and

FIG. 4 is a block diagram showing a configuration of the LED lighting unit of FIG. 1.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, a lighting system according to exemplary embodiments of the present invention will be described with reference to the accompanying drawings.

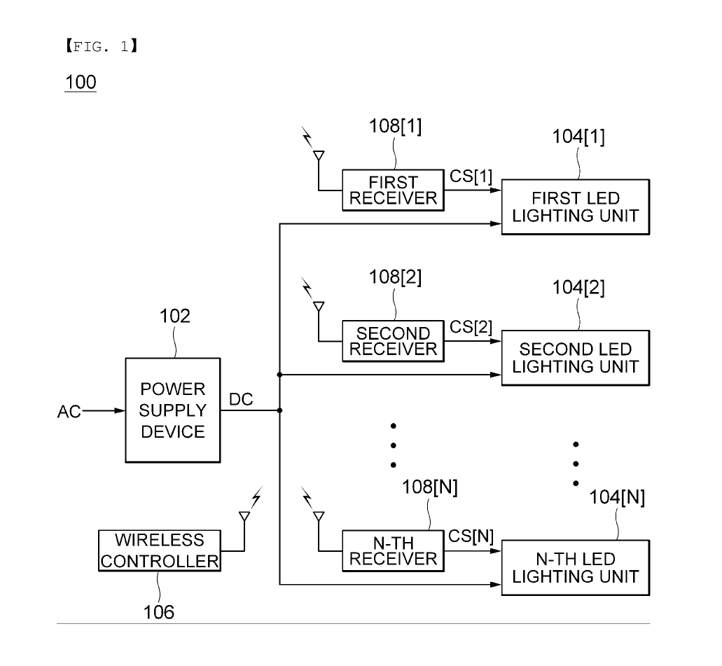

FIG. 1 is a block diagram showing a configuration of a lighting system according to an exemplary embodiment of the present invention.

Referring to FIG. 1, a lighting system 100 includes a power supply device 102, a plurality of lighting units 104 [1:N], a wireless controller 106, and a plurality of receiving units 108 [1:N].

First, the power supply device 102 includes at least two converters receiving AC power and converting it into DC power, and selects and outputs any one DC power thereof. The output DC power is applied to the plurality of LED lighting units 104 [1:N]. Each of the lighting units 104 104[1:N] receives the DC power from the power supply device 102 to be driven.

The wireless controller 106 transmits control signals CS[1:N] to control driving of the LED lighting units 104[1:N], and the plurality of receiving units 108[1:N] receive the control signals CS[1:N] and transfer them to each of the corresponding LED lighting units 104[1:N]. Herein, the control signals CS[1:N] may be ON/OFF control signals of the LED lighting units 104 [1:N], pulse width modulation (PWM) signals, or analog signals in the range of 0V to 10V. The LED lighting unit 104[1:N] includes a plurality of LEDs and receives the control signals CS[1:N], thereby driving the LEDs. For example, the LED lighting unit 104[1:N] may turn-on or turn-off the LEDs according to the control signals CS[1:N] or control brightness of the LEDs according to the received pulse width modulation signals or analog signals. In other words, the brightness is determined according to pulse periods of the control signals CS[1:N] or voltage levels of the analog signals. Meanwhile, the LED lighting units 104[1:N] may be separately or collectively controlled.

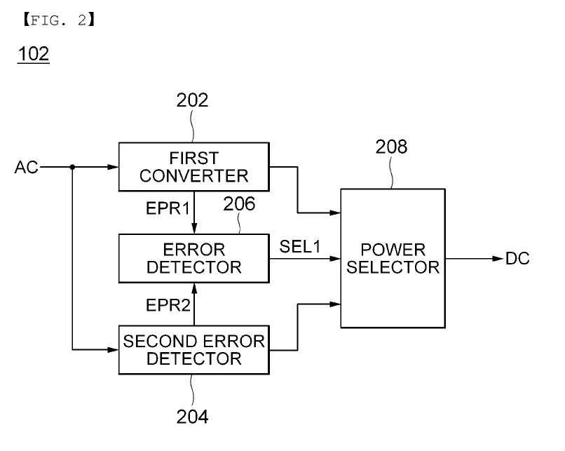

FIG. 2 is an example showing an internal configuration of the power supply device of FIG. 1.

Referring to FIG. 2, the power supply device 102 includes a first converter 202, a second converter 204, an error detector 206, and a power selector 208.

First, the first converter 202 receives AC power and converts it into DC power, and the second converter 204 also receives AC power and converts it into DC power. In this case, the first and second converters 202 and 204 generate DC power having the same magnitude. Herein, the two converters 202 and 204 are shown for convenience of explanation, but a greater number of converters may be included in the power supply device 102.

Meanwhile, the first converter 202 and the second converter 204 generate error signals ERR1 and ERR2 at the time of an abnormal operation, for example, when an AC-DC conversion process is not properly performed or DC power having a desired magnitude is not generated, or the like.

The error detector 206 receives the error signals ERR1 and ERR2 from the first and second converters 202 and 204 and determines which converters of the plurality of converters are normally operating. One of the converters normally operating, which has the highest operation rank, is selected, such that a selection signal SEL1 for selecting DC power of the converter is output. For example, the operation rank of the first converter 202 is higher than that of the second converter 204 when the first and second converters 202 and 204 are normally operating, such that the selection signal SEL1 for selecting the DC power of the first converter 202 is output. On the other hand, when the first converter 202 is abnormally operating and the second converter 204 is normally operating, the selection signal SEL1 for selecting DC power of the second converter 204 of which the operation rank is higher next to the first converter 202 is output. The operating method as described above is applied in the same manner even when the number of converter increases. The power selector 208 receives the DC power from each of the first and second converters 202 and 204, and selects and outputs any one DC power thereof according to the selection signal SEL1.

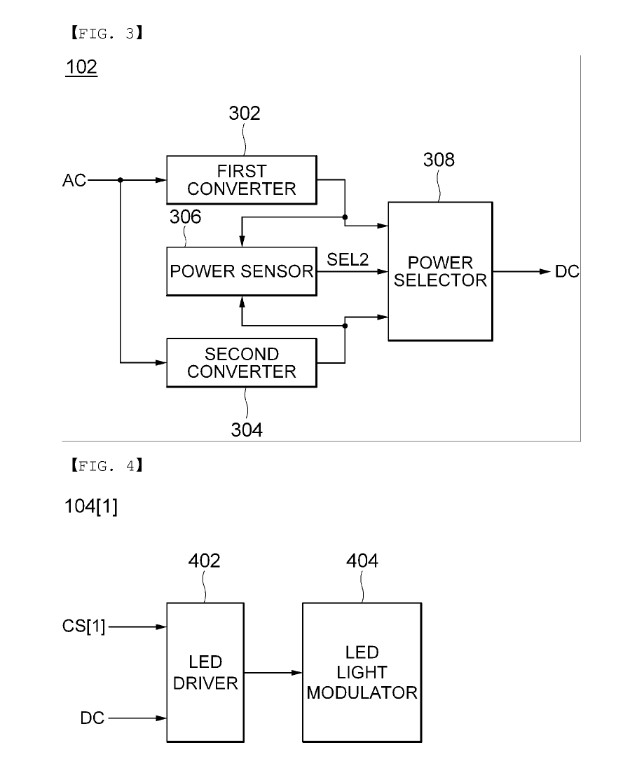

FIG. 3 is another example showing the internal configuration of the power supply device of FIG. 1.

Referring to FIG. 3, the power supply device 102 includes a first converter 302, a second converter 304, a power sensor 306, and a power selector 308.

Each of the first converter 302 and the second converter 304 receives AC power and converts them into DC power having the same magnitude.

The power sensor 306 senses each of the DC power generated from the first and second converters 302 and 304 to determine which converters are normally operating and outputs a selection signal SEL2 for selecting the DC power of one of the converters normally operating, having the highest operation rank. For example, the operation rank of the first converter 302 is higher than that of the second converter 304 when the first and second converters 302 and 304 are normally operating, such that the selection signal SEL2 for selecting the DC power of the first converter 302 is output. On the other hand, when the first converter 302 is abnormally operating and the second converter 304 is normally operating, the selection signal SEL2 for selecting DC power of the second converter 304 of which operation rank is higher next to the first converter 302 is output. The operating method as described above is applied in the same manner even when the number of converter increases.

The power selector 308 receives the DC power from the first converter 302 and the DC power from the second converter 304, and selects and outputs any one DC power thereof according to the selection signal SEL2.

FIG. 4 is a block diagram showing a configuration of the LED lighting unit of FIG. 1.

All the plurality of LED lighting units 104[1:N] shown in FIG. 1 have the same configuration, such that a first LED lighting unit 104[1] of them will be described so as to avoid overlapping.

Referring to FIG. 4, the first LED lighting unit 104[1] includes an LED driver 402 and an LED light modulator 404.

First, the LED driver 402 receives the DC power DC from the power supply device and drives the LED light modulator 404 in response to a control signal CS[1] transferred from the receiving unit. Although not shown, the LED light modulator 404 includes a plurality of LEDs.

The control signal CS[1] may be, for example, ON/OFF control signals of each of the LED lighting units 104[1:N], pulse width modulation (PWM) signals, or analog signals in the range of 0V to 10 v, as described above. When the control signal CS[1] is a pulse width modulation signal, the LED driver 402 controls driving current during a pulse period of the control signal CS[1] and drives the LEDs of the LED light modulator 404. Meanwhile, when the control signal CS[1] is an analogy signal, the LED driver 402 controls the driving current according to voltage levels of the control signal CS[1] and drives the LEDs of the LED light modulator 404. The LEDs emit light by the driving current and at this time, the brightness is varied according to the pulse period of the control signal CS[1]. For example, if the pulse section of the control signal CS[1] is lengthened, the brightness of the LEDs is increased.

As described above, the lighting system according to the exemplary embodiments of the present invention sets the operation ranks of the plurality of converters generating DC power to output the DC power of another converter according to the operation ranks even when some of them abnormally operate, thereby making it possible to stably supply power. In addition, converters are integrated in one power supply device, thereby making it possible to reduce installation costs and facilitate maintenance thereof, as compared to a case where a power supply device is provided for each LED lighting unit.

The exemplary embodiment of the present invention sets operation ranks for each of the plurality of converters generating DC power and controls one of the normally operating converters, having the highest operation rank, to output DC power, even if some of the converters abnormally operate, thereby making it possible to stably supply power.

In addition, according to the exemplary embodiments of the present invention, the power supply device is not installed in each of the LED lighting units but the integrated power supply device supplies power to all of the LED lighting units, thereby making it possible to facilitate maintenance of the power supply device and reduce installation costs thereof.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A power supply device, comprising:
a plurality of converters each receiving AC power and converting it into DC power, and generating error signals at the time of an abnormal operation;
an error detector determining which converters are normally operating from the error signals and outputting a selection signal for selecting one of the normally operating converters according to operation ranks; and
a power selector receiving DC power from the converters and selecting and outputting one DC power according to the selection signal.

2. The power supply device according to claim 1, wherein the converters convert the AC power into DC power having the same magnitude.

3. The power supply device according to claim 1, wherein the error detector selects one of the normally operating converters, having the highest operation rank.

4. A power supply device, comprising:
a plurality of converters each receiving AC power and converting it into DC power;
a power sensor determining which converters are normally operating by sensing DC power of the converters and outputting a selection signal for selecting one of the normally operating converters; and
a power selector receiving DC power from the converters and selecting and outputting one DC power according to the selection signal.

5. The power supply device according to claim 4, wherein the converters convert the AC power into DC power having the same magnitude.

6. The power supply device according to claim 1, wherein the power sensor selects one of the normally operating converters, having the highest operation rank.

7. A lighting system, comprising:
a power supply device including at least two converters that receive AC power and convert it into DC power and selectively outputting any one DC power thereof; and
a plurality of LED lighting units each receiving the DC power from the power supply device and operating.

8. The lighting system according to claim 7, wherein the power supply device selects one of the converters according to operation ranks and outputs the DC power of the selected converter.

9. The lighting system according to claim 7, wherein the converters convert the AC power into DC power having the same magnitude.

10. The lighting system according to claim 7, wherein the power supply device includes:
a plurality of converters each receiving the AC power and converting it into DC power, and generating error signals at the time of an abnormal operation;
an error detector determining which converters are normally operating from the error signals and outputting a selection signal for selecting one of the normally operating converters according to operation ranks; and
a power selector receiving DC power from the converters and selecting and outputting one DC power according to the selection signal.

11. The lighting system according to claim 10, wherein the error detector selects one of the converters, having the highest operation rank.

12. The lighting system according to claim 7, wherein the power supply device includes:
a plurality of converters each receiving the AC power and converting it into DC power;
a power sensor determining which converters are normally operating by sensing DC power of the converters and outputting a selection signal for selecting one of the normally operating converters; and
a power selector receiving DC power from the converters and selecting and outputting one DC according to the selection signal.

13. The lighting system according to claim 12, wherein the power sensor selects one of the normally operating converters, having the highest operation rank.

14. The lighting system according to claim 7, further comprising:
a wireless controller wirelessly transmitting control signals for controlling the operation of each of the LED lighting units; and
a plurality of receiving units receiving the control signals and transferring them to the corresponding LED lighting units.

15. The lighting system according to claim 14, wherein the LED lighting unit includes:
an LED driver generating driving current in response to the control signals; and
an LED light modulator including a plurality of LEDs emitting light by the driving current.
